(19) United States
(12) Patent Application Publication
(10) Pub. No.: US 2004/0064572 A1
(43) Pub. Date: Apr. 1, 2004

(54) Digital service system

(76) Inventors: Katsuhisa Yamaguchi, Kawasaki-shi (JP); Kazuto Washio, Asaka-shi (JP)

Correspondence Address: BIRCH STEWART KOLASCH & BIRCH, PO BOX 747, FALLS CHURCH, VA, 22040-0747, US

(21) Appl. No.: 10/669,210

(22) Filed: Sep. 25, 2003

(30) Foreign Application Priority Data
Sep. 27, 2002 (JP) 2002-282097

(51) Int. Cl. G06F 15/16; G06F 15/173

(52) U.S. Cl. 709/229; 709/225

(57) ABSTRACT

A private, protect or public authorization level is set in a service server that provides a service. The set authorization level and type, etc., indicating the content of the service are transmitted to a center server, which proceeds to generate a management table indicating the content, etc., of the service. If a request for a service list is received from a client computer, then the client computer is sent the service list, which contains the service type, etc., other than that for which the authorization level is private. The client computer requests the service server for a service. If the requested service is of the protect authorization level, authentication is carried out. The authenticated user of the client computer is capable of receiving the service.

### BACKGROUND OF THE INVENTION

1. Field of the Invention

This invention relates to a digital service system, a server, a program for controlling a center server and a recording medium on which this program has been stored.

2. Description of the Related Art

There is system in which customer information and authorization with respect to a printing company are managed by as management server. (For example, see the specification of Japanese Patent Application Laid-Open No. 2002-56254.) This management system, however, is a client-server model. Since commands from client computers concentrate in the server in a client-server model, the load on the server is a heavy one. Peer-to-peer network systems currently are the object of much attention because of their ability to alleviate server load.

By utilizing a peer-to-peer network system, a computer supplying a service is accessed directly to thereby enable receipt of the provided service.

In a peer-to-peer network system according to the prior art, however, all users are capable of accessing computers that constitute the peer-to-peer network system. As a consequence, there are occasions where this system is not suited to a case where it is desired to provide a specific user with a service.

### SUMMARY OF THE INVENTION

Accordingly, an object of the present invention is to provide a specific user with a service.

A digital service system according to the present invention comprises a client computer, a service server and a center server.

The service server includes a first transmitting device (first transmitting means) for sending the center server data indicating the content of a service implemented in the service server, data indicating the authorization level of the service and address data indicating the address of the content server.

The client computer includes a second transmitting device (second transmitting means) for sending the center server a service-list request command.

The center server includes a storage control device (storage control means) for storing the service-content data, service authorization-level data and address data, which has been transmitted from the first transmitting device of the service server, in a management table; a service-list generating device (service-list generating means) for generating a service list, which includes service content and address of the service server, from the data that has been stored in the management table, based upon the service authorization level in response to the service-list request command transmitted from the second transmitting device of the client computer; and a third transmitting device (third transmitting means) for sending the client computer data indicating the service list that has been generated by the service-list generating device.

It may be so arranged that the client computer, service server and center server constituting the digital service system are constructed independently of one another. Further, the invention may be adapted so as to provide methods of controlling the client computer, service server and center server. Further, the invention may be adapted so as to provide programs for controlling the client computer, service server and center server as well as a recording medium on which these programs have been stored.

In accordance with the present invention, data indicating the content of a service implemented in the service server, data indicating the authorization level of the service and address data indicating the address of the content server are transmitted from the service server to the center server. Upon receiving the service-content data, service authorization data and address data, the center server stores these data in the management table.

The user of the client computer that is to receive provision of a service by the service server uses the client computer to request the center server for a service list. In response to the service-list request from the client computer, the center server generates the service list based upon the service authorization level. Data indicating the generated service list is transmitted to the client computer. The service list generated based upon the service authorization level is received at the client computer.

Thus, the client computer receives the service list, which contains service content and the address of the service server that provides the service. The user of the client computer is capable of accessing the service server that provides the desired service from the service content contained in the service list. The user of the client computer can receive the service provided by the service server.

The service list is generated based upon the authorization level transmitted from the service server. As a result, by making the authorization level transmitted from the service server to the center server an authorization level (private) that is for keeping provision of the service secret, the content of the service and the address of the service server can be prevented from being included in the service list. A service can be provided to a specific user and the service provided by the service server can be kept secret from other users. The service afforded by the service server can be provided by separately notifying the user of a client computer that does not require that a service be kept secret.

The client computer may further be provided with a for transmitting a service request to a service server having an address contained in a service list represented by service list data that has been transmitted from the third transmitting device of the center server.

Owing to receipt of the service request by the service server, the user of the client computer can receive a service implemented in the service server.

The service server may further be provided with an authentication device (authentication means) for authenticating the client computer in response to a service request transmitted from the fourth transmitting device of the client computer; and a service execution device (service execution means) for executing processing, which is based upon the service request transmitted from the fourth transmitting device of the client computer, in response to authentication by the authentication device.

Even though the service server that provides a service can be accessed in accordance with the authorization level, the processing that conforms to the service request will not be executed (i.e., protection is provided) unless authentication is achieved. This means that whether a service is provided or not can be set for every client computer.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the general configuration of a digital content system according to an embodiment of the present invention;

FIG. 2 is a block diagram illustrating the electrical structure of a center server;

FIG. 3 illustrates a management table;

FIG. 4 illustrates a service list;

FIG. 5 illustrates a registered user list;

FIG. 6 is a flowchart illustrating processing for generating the management table;

FIG. 7 is a flowchart illustrating processing for transmitting the service list;

FIG. 8 is a flowchart illustrating service execution processing by a client computer;

FIG. 9 is a flowchart illustrating service execution processing by a service server; and

FIG. 10 is a flowchart illustrating user registration processing.

### DESCRIPTION OF THE PREFERRED EMBODIMENTS

An embodiment of the present invention will now be described in detail with reference to the drawings.

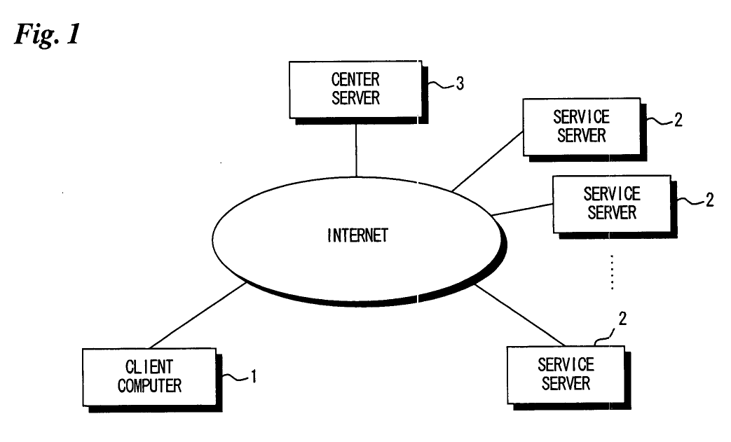

FIG. 1 illustrates an overview of a digital service system according to a preferred embodiment of the invention.

The digital service system shown in FIG. 1 comprises a client computer 1, a number of service servers 2 and a center server 3 that are capable of communicating with one another via the Internet.

The service servers 2 perform services (such as transmission of content such as image data and printing) in accordance with a request from the client computer 1.

Further, in order to facilitate an understanding of this embodiment, the client computer 1 and service servers 2 are described separately. However, operation is as a service server if a service is requested in the client computer 1 and as a client computer if a service is requested in a service server 2.

The digital service system according to this embodiment is such that an authorization level is decided for every service. The user of the client computer 1 is capable of receiving provision of a service in accordance with the authorization level. The description that follows will make this more apparent.

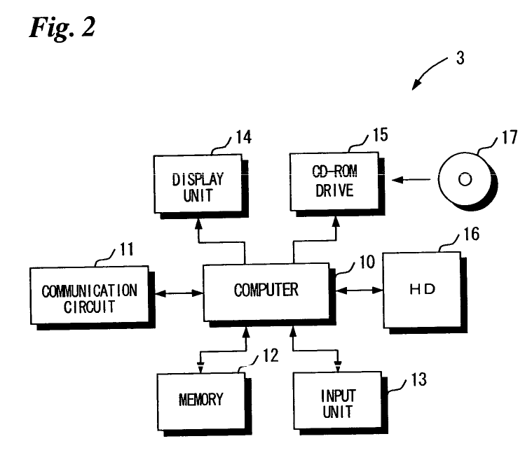

FIG. 2 is a block diagram illustrating the electrical structure of the center server 3. The client computer 1 and service servers 2 have a structure that is similar to that of the center server 3.

The overall operation of the center server 3 is controlled by a computer 10.

The computer 10 includes a communication circuit 11 for implementing communication of data with the client computer 1 and service servers 2, a memory 12 for storing data and the like temporarily, an input unit 13 for applying commands and the like to the computer 10, a display unit 14 and a hard disk 16 for storing management data, etc., described later.

The center server 3 further includes a CD-ROM (compact disk—read-only memory) 17 and a CD-ROM drive 15. The CD-ROM 17, which stores a program for carrying out an operation described later, is accessed by the CD-ROM drive 15. The program read from the CD-ROM 17 is installed in the computer 10.

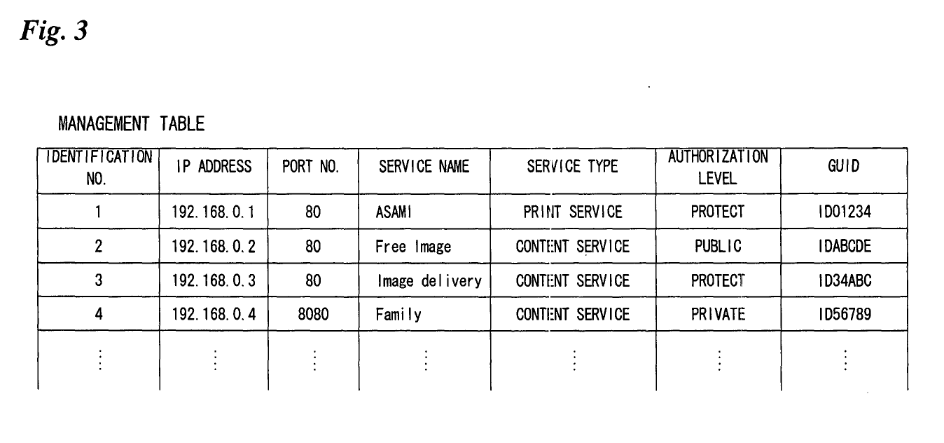

FIG. 3 illustrates an example of a management table stored on the hard disk 16 of the center server 3.

Management data contained in the management table includes identification numbers, IP (Internet Protocol) addresses and port numbers of the service servers 2, service names for identifying services, service types representing the types of services, authorization levels that decide levels that allow services, and unique GUIDs (Global Unique Identification Numbers) for every service server 2 and provided service. A GUID that i spec fi to each service would be generated based upon transmission time (obtained from a timer, which is not shown) and the IP address, etc., of the service server. These items of management data are transmitted from the service server 2 to the center server 3 with the exception of the identification number. The identification number is assigned in the center server 3 in accordance with transmission of an IP address, etc., from the service server 2.

In this embodiment, there are three types of authorization level, namely public, protect and private. The public level provides the service to all users. The protect level stores the service name, etc., in a service list (described later) and reports the IP address, etc., of the service server 2 to the client computer 1 that has requested the service list. If a user has been authenticated, the protect level provides the service. The private level is such that the IP address, etc., of a service server that provides a service will not be stored in the service list. A private service would be one in which the client computer 1 requesting service is notified as by e-mail of the IP address, etc., from the service server 2 that provides the private service.

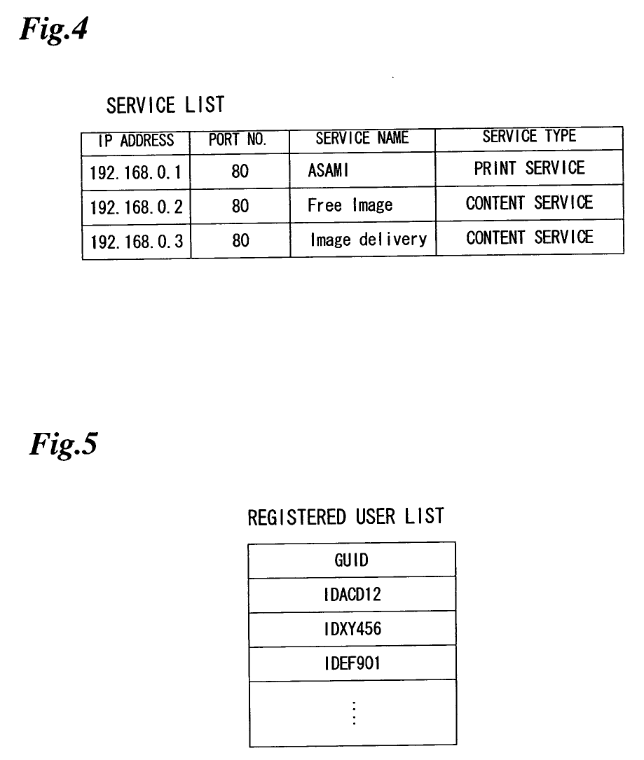

FIG. 4 shows an example of a service list generated by the center server 3.

The service list is generated based upon the above-described management table. The service list contains the IP addresses and port numbers of the service servers 2 as well as the service names and service types.

As mentioned above, the service list is generated using management data for which the authorization levels are protect and public from among the management data contained in the management table.

The service list is generated by the center server 3 in accordance with a request from the client computer 1.

FIG. 5 shows an example of a registered user list.

The registered user list is generated by the service servers 2 on a per-service basis and is composed of a plurality of GUIDs. It is required that the user of the client computer 1 that receives provision of services having the protect and private authorization levels be registered beforehand with the service servers 2 on a per-service basis. A registered user list is composed of registered GUIDs for every service of the client computer 1 for which the user has been registered in advance. An authenticated user of the client computer 1 is capable of receiving a private or protect service using the registered user list.

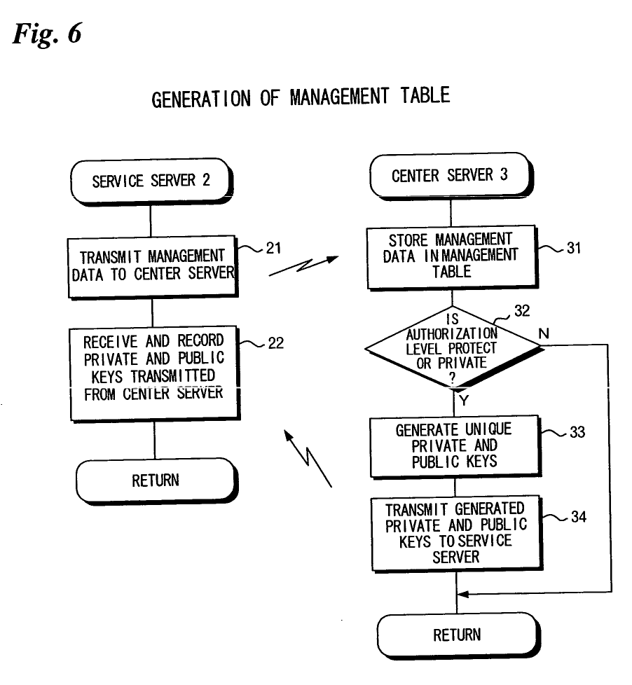

FIG. 6 is a flowchart of processing executed by the service server 2 and center server 3 for generating a management table.

A service namer service type and service authorization level are set in the service server 2 in accordance with the service to be provided. When this is accomplished, a GUID is generated based upon the set time and the IP address of the service server 2. The management data consisting of the IP address, port number, service name, service type, authorization level and GUID is transmitted from the service server 2 to the center server 3 (step 21).

When the management data transmitted from the service server 2 is received by the center server 3, the management data is stored in the management table upon being assigned an identification number (step 31).

The authorization level is read from the management data contained in the management table. If the read authorization level is protect or private (“YES” at step 32), then the computer 10 of the center server 3 generates a private- and public-key pair that is specific to each service (step 33). The generated private and public keys are transmitted from the center server 3 to the service server 2 (step 34). If the authorization level is neither protect nor private, i.e., is public (“NO” at step 32), then the processing of steps 33 and 34 is skipped.

When the private and public keys transmitted from the center server 3 are received by the service server 2 that transmitted the management data, the service server 2 records the keys in correspondence with the set service type, etc. (step 22). Processing (described later) for authenticating the user of the client computer 1 is executed using the private and public keys.

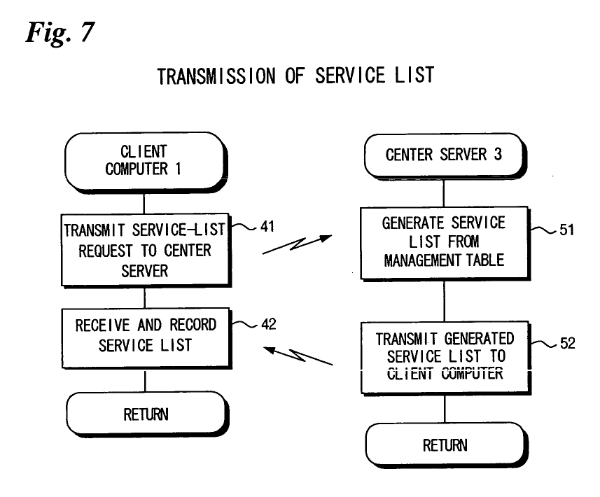

FIG. 7 is a flowchart of processing executed by the client computer 1 and center server 3 for transmitting the service list.

A request for the service list is transmitted from the client computer 1 to the center server 3 (step 41).

When the service-list request transmitted from the client computer 1 is received by the center server 3, the latter generates the service list from the management table in the manner described above (step 51). Specifically, from among management data for which the authorization level is other than private, the IP address and port number as well as the service name and service type are extracted and the service list is generated. The generated service list is transmitted to the client computer 1 that requested it (step 52).

When the service list transmitted from the center server 3 is received by the client computer 1, the service list is recorded in a predetermined memory area of the client computer 1 (step 42). The user of the client computer 1 checks the service name and service type that have been stored in the service list. The IP address and port number of the service server 2 performing the desired service are read from the service list. A service request is issued to the service server 2 having the read IP address and port number.

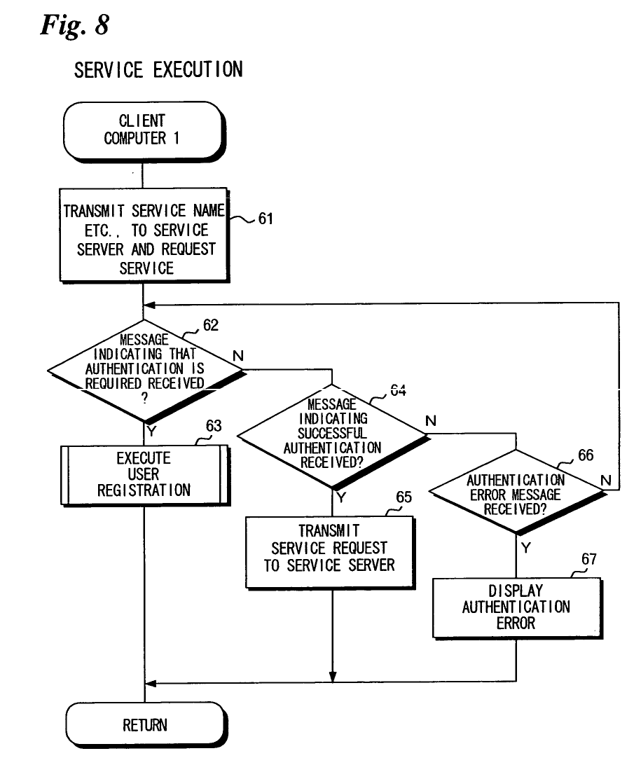

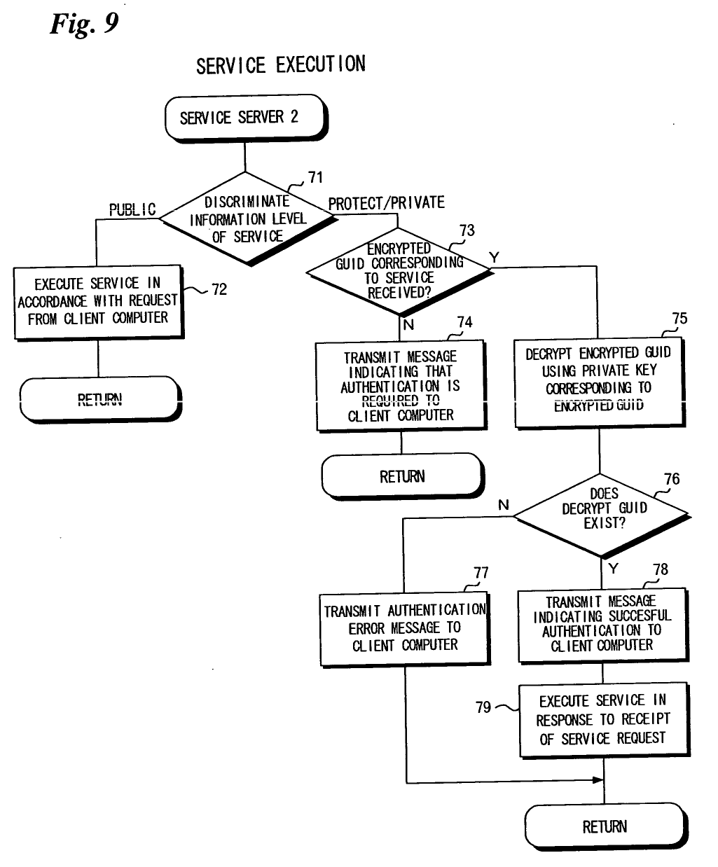

FIGS. 8 and 9 are flowcharts illustrating processing for service execution, in which FIG. 8 is a flowchart of processing executed by the client computer 1 and FIG. 9 a flowchart of processing executed by the service server 2.

The service list transmitted from the center server 3 as described above is received by the client computer 1. The service names and service types contained in the service list are displayed on the display screen of a display unit of the client computer 1. By referring to the displayed service names and service types, the user of the client computer 1 selects the service name and service type corresponding to the service desired to be received. Data representing the selected service name and service type is transmitted from the client computer 1 to the service server 2 having the IP address and port number corresponding to the selected service name, etc. (step 61).

In a case where the authorization level is protect, as mentioned above (if the authorization level is private, data such as a service name is not stored in the service list and, hence, a private service name, etc., cannot be selected from the service list), authentication processing is necessary. The authentication processing makes use of a GUID that corresponds to the service and that has been encrypted, as will be described later. This means that in a case where a service name, etc., is transmitted, a GUID that corresponds to the service name, etc., transmitted and that has been encrypted is also transmitted from the client computer 1 to the service server 2.

If a service name, etc., transmitted from the client computer 1 is received by the service server 2, then the authorization level corresponding to this service name, etc., is discriminated (step 71).

If the authorization level is public, the service has been made public and therefore the service is executed in accordance with the request from the client computer 1 (step 72). For example, if the service type is content service, then content such as image data conforming to the request from the client computer 1 is transmitted to the client computer 1.

If the authorization level is protect or private (in case of the private authorization level, the user of the client computer would not have selected a service name, etc., from the service list but the IP address and service name, etc., would have been given separately by the user of the service server 2, as mentioned above), it is determined whether the corresponding encrypted GUID has been received with receipt of the service name, etc. (step 73).

If an encrypted GUID is not received, the user of the client computer 1 that issued the request is regarded as being unregistered. A message to the effect that authentication is required is transmitted from the service server 2 to the client computer 1 (step 74).

If the message to the effect that authentication is required is received from the service server 2 (“YES” at step 62), the client computer 1 executes user registration, described later (step 63). The encrypted GUID corresponding to the service is transmitted to the client computer 1 by user registration. Authentication is carried out by transmission of the corresponding encrypted GUID from the client computer 1 to the service server 2 with transmission of the service name.

If the encrypted GUID is received by the service server 2 in association with the service (“YES” at step 73), processing for decryption the encrypted GUID is executed using the secret key transmitted from the center server 3 in association with this service (step 75). If decryption is successful (“YES” at step 76), it is determined whether a corresponding GUID exists among the GUIDs that have been stored in the user registration list of the corresponding service. If the decrypted GUID has been registered in the user registration list, a message indicating success of authentication is transmitted from the service server 2 to the client computer 1 (step 78).

If a message indicating success of authentication transmitted from the service server 2 is received by the client computer 1 (“YES” at step 64), the latter transmits a service request to the service server 2 (step 65).

A service conforming to the service type is executed by the service server 2 in accordance with the service request transmitted from the client computer 1 (step 79).

If the service server 2 finds that the decrypted GUID does not exist (“NO” at step 76), then the service server 2 transmits an authentication error message to the client computer 1 (step 77).

The client computer 1 receives the authentication error message transmitted from the service server 2 (“YES” at step 66), whereupon authentication error is displayed on the display screen of the display unit of client computer 1 (step 67). User registration would be carried out by the service server 2 if necessary in response to viewing of the displayed error message.

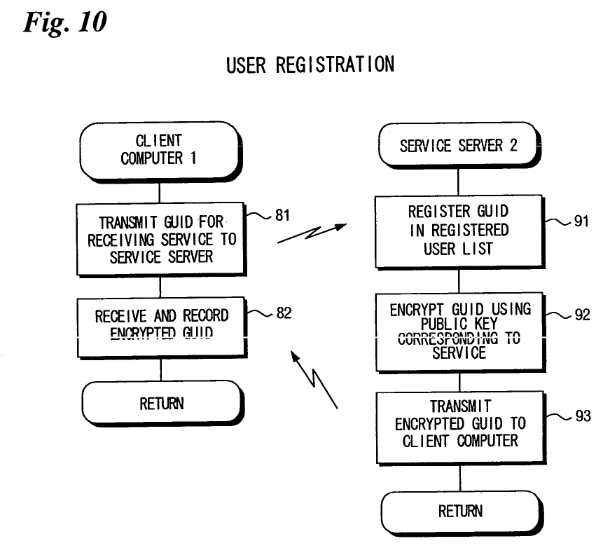

FIG. 10 is a flowchart illustrating processing for user registration (the processing of step 63 in FIG. 8).

A GUID is generated by the client computer 1 in association with the service to be received. The generated GUID is transmitted to the service server 2 that provides the service (step 81).

If the GUID transmitted from the client computer 1 is received by the service server 2, then the received GUID is registered in the user registration list corresponding to the service (step 91). Furthermore, the GUID transmitted from the client computer 1 is encrypted using the public key transmitted from the center server 3 (step 92). The encrypted GUID is transmitted from the service server 2 to the client computer 1 (step 93).

The encrypted GUID transmitted from the service server 2 is received by the client computer 1 and recorded (step 82). If the encrypted GUID is thus received and registered by the client computer 1, it is transmitted to the service server 2 together with the service name, as mentioned above, when provision of the service is received by the service server 2.

As many apparently widely different embodiments of the present invention can be made without departing from the spirit and scope thereof, it is to be understood that the invention is not limited to the specific embodiments thereof except as defined in the appended claims.

What is claimed is:

1. A digital service system comprising a personal computer, a service server and a center server, wherein said service server includes a first transmitting device for sending said center server data indicating content of a service implemented in said service server, data indicating the authorization level of the service and address data indicating the address of the content server;
said client computer includes a second transmitting device for sending said center server a service-list request command; and
said center server includes:
a storage control device for storing the service-content data, service authorization-level data and address data, which has been transmitted from said first transmitting device of said service server, in a management table;
a service-list generating device for generating a service list, which includes service content and address of said service server, from the data that has been stored in the management table, based upon the service authorization level in response to the service-list request command transmitted from said second transmitting device of said client computer; and
a third transmitting device for sending said client computer data indicating the service list that been generated by said service-list generating device.

2. The system according to claim 1, wherein said client computer further includes a fourth transmitting device for transmitting a service request to a service server having an address contained in a service list represented by service list data that has been transmitted from said third transmitting device of said center server.

3. The system according to claim 1, wherein said service server further includes:
an authentication device for authenticating said client computer in response to a service request transmitted from said fourth transmitting device of said client computer; and
a service execution device for executing processing, which is based upon the service request transmitted from said fourth transmitting device of said client computer, in response to authentication by said authentication device.

4. A center server comprising:
a storage control device for receiving data indicating content of a service by a service server, data indicating service authorization and data indicating an address, these items of data being transmitted from the service server, and storing this data in a management table;
a service-list generating device for generating a service list, which includes service content and address of said service server, from the data that has been stored in the management table, based upon a service authorization level in response to a service-list request command transmitted from a client computer; and
a transmitting device for sending-the client computer data indicating the service list that has been generated by said service-list generating device.

5. A method of controlling a center server, comprising the steps of:
receiving, and storing in a management table, data indicating content of a service by a service server, data indicating service authorization and data indicating an address, these items of data being transmitted from the service server;
generating a service list, which includes service content and address of the service server, from the data that has been stored in the management table, based upon a service authorization level in response to a service-list request command transmitted from a client computer; and
sending the client computer data indicating the service list that has been generated.

6. A program for controlling a center server so as to:
receive, and store in a management table, data indicating content of a service by a service server, data indicating service authorization and data indicating an address, these items of data being transmitted from the service server; and
generate a service list, which includes service content and address of the service server, from the data that has been stored in the management table, based upon a service authorization level in response to a service-list request command transmitted from a client computer.

7. A recording medium storing the program set forth in claim 6.
